(19) United States
(12) Patent Application Publication
(10) Pub. No.: US 2014/0122031 A1
(43) Pub. Date: May 1, 2014

(54) SYSTEM, APPARATUS AND METHOD FOR PROVIDING INDOOR INFRASTRUCTURE SERVICE

(71) Applicant: Electronics and Telecommunications Research Institute, Daejeon (KR)

(72) Inventor: Yu-Cheol LEE, Daejeon (KR)

(73) Assignee: Electronics and Telecommunications Research Institute, Daejeon (KR)

(21) Appl. No.: 14/059,943

(22) Filed: Oct. 22, 2013

(30) Foreign Application Priority Data
Oct. 25, 2012 (KR) 10-2012-0119084

(51) Int. Cl. G06F 17/50

(52) U.S. Cl. CPC G06F 17/5004
USPC 703/1

(57) ABSTRACT

An apparatus for providing information on an indoor infrastructure includes a search request receiving unit configured to receive a search request for a specific indoor space from any terminal. Further, the apparatus includes an information providing unit configured to transmit a map and spatial information corresponding to the specific indoor space to the terminal for the display thereof. Furthermore, the apparatus includes a node information providing unit configured to, when a specific node is selected in the displayed map and spatial information, search a video image, POI information or location information corresponding to the specific node and provide the searched result to the terminal.

### CROSS-REFERENCE TO RELATED APPLICATION(S)

The present invention claims priority of Korean Patent Application No. 10-2012-0119084, filed on Oct. 25, 2012, which is incorporated herein by reference.

### FIELD OF THE INVENTION

The present invention relates to a provision of information on an indoor space, and more particularly, to a system, apparatus and method for providing information an indoor infrastructure, which is capable of constructing an indoor space in a map type of infrastructure and providing the constructed infrastructure information about an indoor space to a user.

### BACKGROUND OF THE INVENTION

With the development of spatial construction technologies, map information that the user needs can be provided to the car, human and the like in the outdoor space, a variety of services utilizing this map information has been used. The presence of positioning technologies such as a GPS (Global Positioning System) in an outdoor space makes it possible to construct an outdoor map.

However, due to the lack of accurate indoor Positioning technology, it is difficult to get the accurate information on an indoor space, and thus only the information, such as CAD drawings is utilized instead of an indoor map. Therefore, research has been actively investigated on technology for building different information such as indoor positioning technology, indoor space structure, and others in the form of information infrastructure. When providing information on indoor spaces to the user, there is a possibility that various services can be offered, and thus there is a possibility of developing a new business. For example, a number of portal sites for providing Internet search provide a map of the outdoor space and different information related to the outdoor space to the users, to thereby give the users much convenience in using information about the outdoor space, and from the viewpoint of companies, the added value may be increased due to the creation of a variety of services. Therefore, similarly to the outdoor space, if the ability is provided to normalize a map of the indoor space and the various information related to the indoor space, the users may be received various services such as optimal route planning, orientation and the like, and companies can create an additional revenue source derived from the service. Furthermore, enterprises that are registered on the map may benefit from such advertising effectiveness.

For this reason, many researchers and developers has researched and developed a technique capable of accurately normalizing and creating information on the indoor space in the form of infrastructure and a method of providing it as a service.

### SUMMARY OF THE INVENTION

In view of the above, the present invention provides a system for providing information on an indoor infrastructure, which is capable of providing information on an indoor space in the form of an infrastructure.

Further, the present invention provides an apparatus for providing information on an indoor infrastructure, which is capable of providing infrastructure information in response to a user's request.

Further, the present invention provides a method for providing information on an indoor infrastructure, which is capable of utilizing infrastructure information on an indoor space.

In accordance with a first aspect of the present invention, there is provided a system for providing information on an indoor infrastructure, which includes: a spatial information acquiring apparatus configured to acquire a video image of a space, wireless network information, distance information or distance and angle information that a moving object moves to produce a space-acquired data; a node information generation apparatus configured to estimate a location of the moving object on the basis of the distance and angular information that the moving object moves with the movement of the moving object and produce a plurality of moving object node information with the movement of the moving object using the estimated location information, the video image, the wireless network information, the distance information or POI (Point Of Interest) information extracted from the video image; a spatial information generation apparatus configured to correct the location of the moving object on the basis of the location information of the respective moving object node information and produce final spatial information data using the moving object node information with a corrected location; and a map generation apparatus configured to produce a map and spatial information of the space on the basis of the final spatial information data.

In the embodiment, the spatial information acquiring apparatus includes: a camera configured to provide the video image; a radio detector configured to detect the wireless network information; a distance measurement sensor configured to measure a 2D and 3D distance within the space; and an encoder configured to extract the distance and angle information that the moving object moves.

In the embodiment, the spatial information acquiring apparatus further includes: a synchronization module configured to synchronize the video image, the wireless network information and the distance and angle information that the moving object moves and store the same to a data storage unit.

In the embodiment, the node information generation apparatus includes: a location prediction unit configured to predict the location that the moving object moves on the basis of the distance and angle information that the moving object moves; a node database that stores information on reference nodes to which location information is mapped; a location estimation unit configured to search the node database for a reference node having similar location information to the predicted location within a predetermined range and estimate the location of the moving object on the basis of the location information of the searched reference node and the distance information; and a node information generation unit configured to produce a new node in the space based on the estimated location and perform a mapping of the space-acquired data to the new node to produce the moving object node information.

In the embodiment, the node information generation unit is configured to extract the POI information using the video image in the space-acquired data.

In the embodiment, the map generation apparatus includes: a contour map generation unit configured to generate a contour map in a raster format containing nodes and video image in the respective nodes based on the respective moving object node information on the basis of the location and distance information of the moving object in the moving object node information; a vector map generation unit configured to generate a map in a vector format based on the contour map; a POI information production unit configured to produce the POI information on the basis of the video image of the nodes in the contour map in a raster format; a node and link information production unit configured to produce a topology node and link information for a route planning within the space; and a map information DB that stores the contour map, the vector format map, the video image, the POI information, the wireless network information and the topology node and link information.

In accordance with a second aspect of the present invention, there is an apparatus for providing information on an indoor infrastructure, which includes: a search request receiving unit configured to receive a search request for a specific indoor space from any terminal; an information providing unit configured to transmit a map and spatial information corresponding to the specific indoor space to the terminal for the display thereof; a node information providing unit configured to, when a specific node is selected in the displayed map and spatial information, search a video image, POI information or location information corresponding to the specific node and provide the searched result to the terminal.

In the embodiment, the information providing unit is configured to provide an outdoor map containing the specific indoor space, and the information providing unit is configured to, when a specific location is manipulated in the outdoor map, provide a map and spatial information of the indoor space corresponding to the specific location to the terminal for the display thereof.

In the embodiment, the search request receiving unit is configured to receive the search request on the basis of POI information located within the specific indoor space.

In accordance with another aspect of the exemplary embodiment of the present invention, there is a method for providing information on an indoor infrastructure, which includes: receiving a search request for a specific indoor space from any terminal; providing a map and spatial information corresponding to the specific indoor space to the terminal to display the same; when a specific node is selected in the displayed map and spatial information, searching a video image, POI information or location information corresponding to the selected node and providing the searched result to the terminal.

In the embodiment, the receiving a search request includes: receiving the search request that uses any POI information within the specific indoor space.

In the embodiment, the providing to display includes: displaying on the terminal an outdoor map containing the specific indoor space; and displaying on the terminal an enlarged specific indoor space having nodes in the displayed outdoor map.

In the embodiment, the providing to display further includes: displaying information about a current location of the terminal in the displayed specific indoor space.

In the embodiment, the displaying information about a current location of the terminal comprises displaying information about a changed current location of the terminal in the displayed specific indoor space with the movement of the terminal.

In accordance with a third aspect of the present invention, an indoor space is constructed in the map type of infrastructure and the infrastructure of the indoor space is provided to users. Therefore, it is possible for users to utilize infrastructure information of the indoor space infrastructure information conveniently.

Further, the indoor space is created in the form of a map, and thus it is possible not only to extend the service for providing indoor infrastructure information and but also to provide an abundance of life of the user.

### BRIEF DESCRIPTION OF THE DRAWINGS

The above and other objects and features of the present invention will become apparent from the following description of the embodiments given in conjunction with the accompanying drawings, in which:

FIG. 1 is a block diagram illustrating an overall configuration of a system for providing information on an indoor infrastructure in accordance with an embodiment of the present invention;

FIG. 2 illustrates a configuration of a moving object used with a system for providing information on an indoor infrastructure in accordance with an embodiment of the present invention;

FIG. 3 is a block diagram showing an internal configuration of a node information generation apparatus in a system for providing information on an indoor infrastructure in accordance with an embodiment of the present invention;

FIG. 4 illustrates a configuration of a moving object node information DB in detail the node information generation apparatus in accordance with an embodiment of the present invention;

FIG. 5 is a detailed block diagram of a spatial information generation apparatus in a system for providing information on an indoor infrastructure in accordance with an embodiment of the present invention;

FIG. 6 is a detailed block diagram of a map generation apparatus in a system for providing information on an indoor infrastructure in accordance with an embodiment of the present invention;

FIG. 7 is a detailed block diagram of a service server in a system for providing information on an indoor infrastructure in accordance with an embodiment of the present invention; and

FIG. 8 is a flow diagram illustrating a process of providing information on an indoor infrastructure from the service server in accordance with an embodiment of the present invention.

### DETAILED DESCRIPTION OF THE EMBODIMENTS

Hereinafter, the embodiments of the present invention of acquiring information about an interest important region inclusive of a map of an indoor space, generating infrastructure information, and providing a service using the generated infrastructure information will be described in detail with reference to the accompanying drawings.

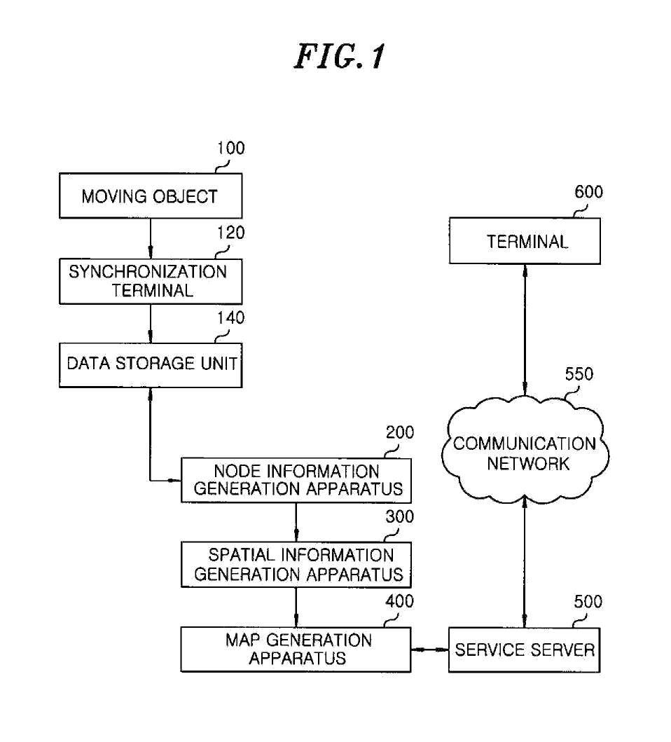

FIG. 1 is a block diagram illustrating an overall configuration of a system for providing information on an indoor infrastructure in accordance with an embodiment of the present invention. The system includes a moving object 100, which acts as a spatial information acquiring apparatus, a synchronization module 120, a data storage unit 140. The system also includes a moving object node information generation apparatus 200, a spatial information generation apparatus 300, a map generation apparatus 400, a service server 500, a communication network 550, and one or more terminals 600. In this case, the moving object 100 is capable of moving within an indoor space in order to acquire indoor information on the indoor space.

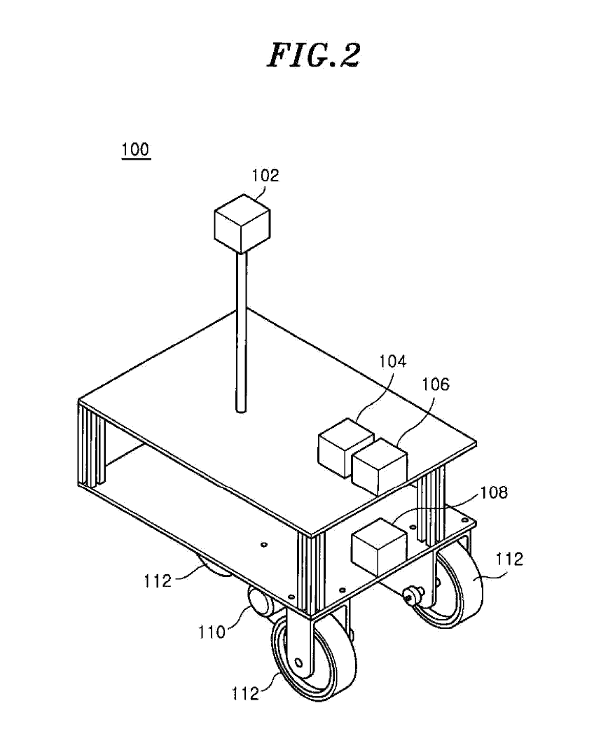

Referring to FIG. 2, the moving object 100 includes a camera 102, a radio detector 104, a 3D distance measuring sensor 106, a 2D distance measuring sensor 108, an encoder 110 and a plurality of wheels 122, all of which are mounted on the moving object 100.

The camera 102 acquires videos of the indoor space with the movement of the moving object 100.

The radio detector 104 detects a MAC address, SSID (Service Set Identifier) and radio strength of access points (APs) installed in a wireless network, for example, WiFi (Wireless-Fidelity) network.

The 3D distance measuring sensor 106 obtains 3D distance information on a space, and the 2D distance measuring sensor 108 obtains 2D distance information on a space. Two or more of the 3D and 2D distance measuring sensors 106 and 108 may be mounted on the moving object 100.

The encoder 110 measures a distance and angle that the moving object 100 moves.

The information measured by the moving object 100 is stored in the data storage unit 140 through the synchronization module 120.

The synchronization module 120 synchronizes data measured by the moving object 100, that is, a video image captured by the camera 102, a MAC address, SSID and radio strength measured by the radio detector 104, distance information measured by the 3D and the 2D distance measuring sensors 106 and 108, and moved distance and angle information and produces normalize data (hereinafter, referred to as ‘space-acquired data’), which will then be stored in the data storage unit 140.

The synchronization module 120 and the data storage unit 140 may be mounted on the moving object 100 as shown, or separately constructed from the moving object 100 so that the measured information can be received through communication with the moving object 100.

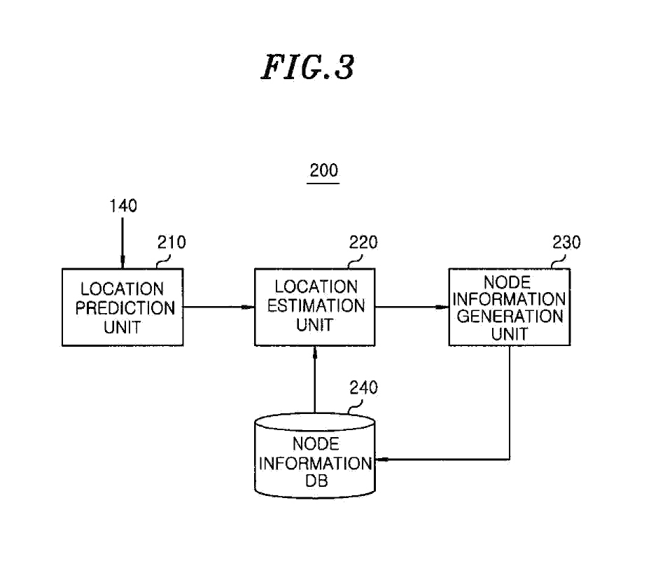

The node information generation apparatus 200 produces a plurality of moving object node information with the movement of the moving object 100. In this case, the moving object node information may include location information of the moving object, video images, information related to a wireless network, distance information, POI (Point Of Interest) and the like. Details of the node information generation apparatus 200 will be described with reference to FIG. 3 as below.

FIG. 3 is a block diagram showing an internal configuration of the node information generation apparatus in accordance with an embodiment of the present invention.

Referring to FIG. 3, the node information generation apparatus 200 predicts and estimates the location of the moving object 100 based on the space-acquired data stored in the data storage unit 140 to produce a new node of the moving object 10. To do it, the node information generation apparatus 200 includes a location prediction unit 210, a location estimation unit 220, a node information generation unit 230 and a node information DB 240.

The location prediction unit 210 predicts a location that the encoder 110 moves on the basis of the encoder information measured by the encoder 110 in the moving object 100, i.e., the distance and angle that the moving object moves.

The location estimation unit 220 searches the node information DB 240 for reference location data having a value of location information most similar to the predicted location and performs a comparison/matching the reference location data, the predicted location, the obtained distance information to estimate the location of the moving object 100. In this case, the reference location data represents a value of the location of the moving object having a value of location information most similar to the predicted location. A comparison/matching method may employ a variety of matching methods such as an Iterative Closet Point using a distance difference having the smallest value, a Sum of Gaussian method using the smallest error rate for each distance, a Polar Scan Matching that is able to execute in the earliest time, or a Map Matching to compare and analyze with a previously generated map, or the like.

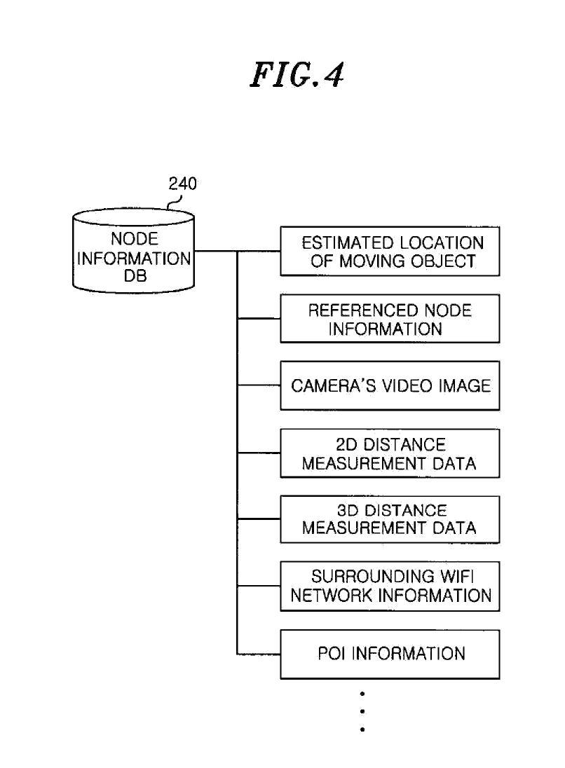

The node information generation unit 230 generates a new node based on the estimated location of the moving object 100 and produces moving object node information using the generated now node and its related various information. The produced moving object node information is stored in the node information DB 240. The moving object node information, as shown in FIG. 4, may include an estimated location of the moving object, node information referenced to estimate the moving object, camera's video images, 2D distance measurement data, 3D distance measurement data, surrounding WiFi network information, inclusive of POI information extracted from the video images. The POI information may include a variety of information such as trade names, staircases, emergency exits and exits and may be extended by adding other information.

When the moving object node information is accumulated in the node information DB 240, the moving object node information generation apparatus 300 performs a correction of the location of the moving object 100 and produces final spatial information data using the moving object node information with a corrected location.

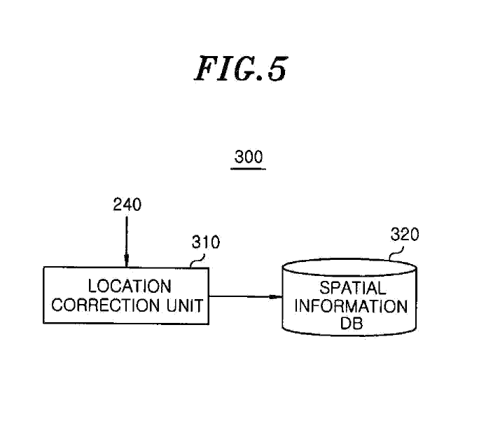

For this purpose, as shown in FIG. 5, the moving object node information generation apparatus 300 is composed of a location correction unit 310 and a spatial information DB 320.

The location correction unit 310 performs a position correction of the moving object 100. Specifically, for a position correction of the moving object, the location correction unit 310 analyzes the information accumulated in the node information DB 240 to correct the positions of respective node information with a minimum error between the Positions of the nodes. In this case, a method of analyzing an error may frequently use a numerical analysis method such as Newton Gaussian, Levenberg and the likes.

In this way, a position of the estimated moving object in the moving object node information is corrected, and thus the final spatial information data is then produced. The final spatial information data is then stored in the spatial information DB 320.

The map generation apparatus 400 generates a map of a space and its related spatial information on the basis of the final spatial information data.

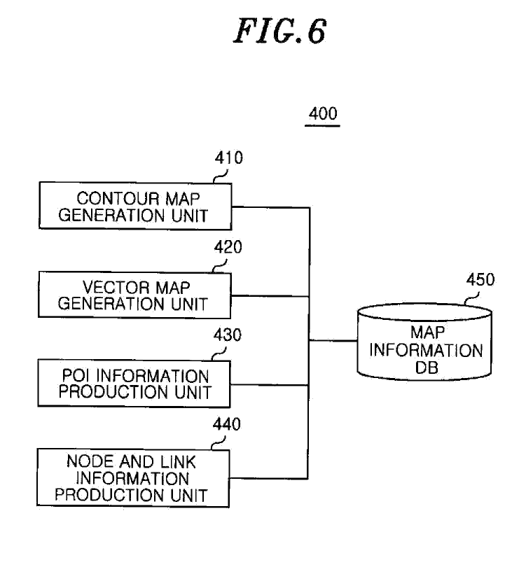

For this object, the map generation apparatus 400, as shown in FIG. 6, a contour map generation unit 410, a vector map generation unit 420, a POI information production unit 430, a node and link information production unit 440, and a map information DB 450.

The contour map generation unit 410 generates a contour map in a raster format using the location information of the moving object from the final spatial information data and the values of the 2D distance measured by the 2D distance measuring sensor 108. The contour map in a raster format includes information of a moving object node and a video image captured by the camera 102 on the same node.

The vector map generation unit 420 generates a map in a vector format such as SVG or DFX file standard based on the contour map.

The POI information production unit 430 provides an interface for entering POI information on the basis of the video image of each moving object node. In this case, the POI information includes, for example, the outlet of the space, a trade name of a shop, stairs and the like, but is not limited thereto.

Meanwhile, the node and link information production unit 440 produces topology node and link information for the route planning.

The map and its related spatial information such as the raster format map, vector format map, POI information, video images, surrounding wireless network information, and topology node and link information are stored in the map information DB 450.

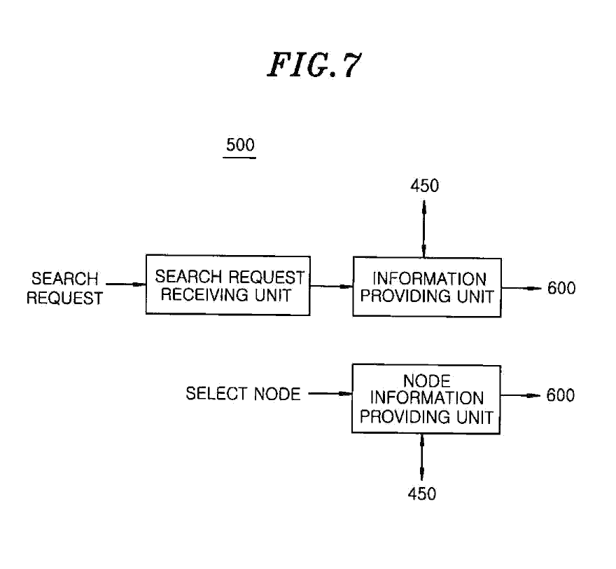

The service server 500 may be an apparatus for providing indoor infrastructure information which is capable of transferring the map and spatial information stored in the map information DB 450 to a plurality of terminals 600 which are connected via wired or wireless network 550. As shown in FIG. 7, the service server 500 includes a search request receiving unit 510, an information providing unit 520 and a node information providing unit 530.

The search request receiving unit 510 receives a search request for a specific indoor space from any terminal 600. In this case, the search request may be a request for information on a specific indoor space using specific POI information.

In response to the search request, the information providing unit 520 searches the map information DB 450 for map and spatial information corresponding to the specific indoor space and provides the searched map and spatial information to the terminal 600. As a result, a map corresponding to the specific indoor space is displayed on the terminal 600.

The information providing unit 520 provides to the terminal 600 an outdoor map corresponding to an outdoor space that includes the indoor space that has requested to search. Thereafter, when the user selects a specific location on the outdoor map, the information providing unit 520 provides a map and spatial information of an indoor space corresponding to the selected specific location.

When a particular node is selected from the map and spatial information that are displayed on the terminal, the node information providing unit 530 retrieves a video image, POI information or location information corresponding to the selected node and provides the retrieved result to the terminal 600.

Each of the terminals 600 is able to request the map and spatial information for a specific location or POI information and the service server 500, in response to the request from the respective terminals 600, searches the map information DB 450 for the map and spatial information corresponding to the specific location or POI information and provides the searched map and spatial information to the respective terminals 600.

In this regard, the terminals 600 may include personal computers, which can be connected to a communication network such as the Internet, mobile devices and mobile phones that can be connected to a wireless network.

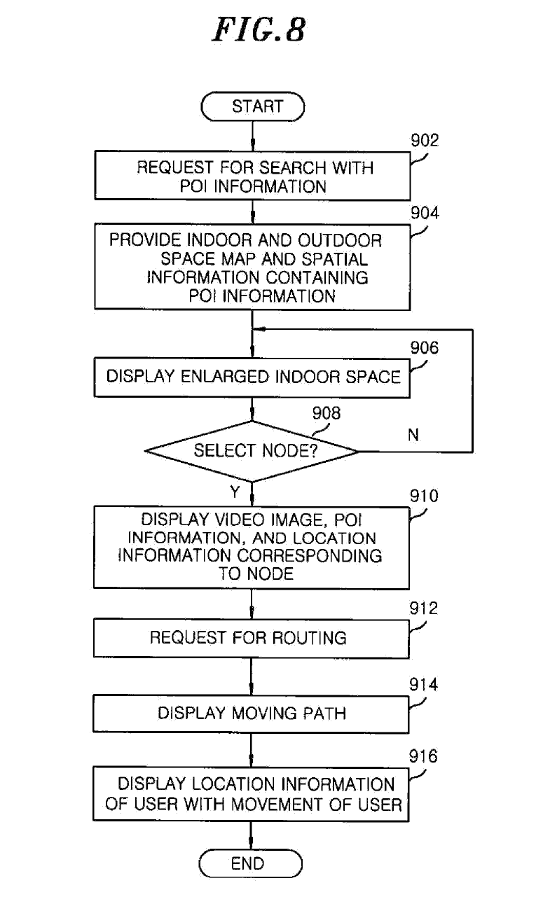

Hereinafter, a process of providing information on an indoor infrastructure by a system for providing information on an indoor infrastructure to the users will be described with reference to FIG. 8.

Referring to FIG. 8, the process begins with an operation 902 where a user requests a search for POI information registered in the indoor space infrastructure. The terminal 600 of the user then makes a request for an indoor infrastructure service to the service server 500 using the POI information, which has been requested for search.

The service server 500 transmits map and spatial information of indoor and outdoor space containing the POI information, which has requested to search, to the user's terminal 600 via the communication network 550, in an operation 904.

The terminal 600 displays an enlarged indoor space containing the POI information that has requested for the search in the outdoor space that is displayed, in an operation 906.

Subsequently, when the user selects any one of moving object nodes, in an operation 908, the user's terminal 600 then retrieves a video image, POI information and location information corresponding to the selected node and displays the retrieved result, in an operation 910.

Next, when there is a request for routing by entering a user's destination, in an operation 912, the user's terminal 600 displays a moving path to the destination with a current location of the user as a starting point, in an operation 914. In this case, information on the current location of the user may be obtained through the use of information detected by the sensor that is able to recognize a location such as a WiFi ΔP, or information from a GPS installed in the terminal 600.

With the movement of the user, the user's terminal 600 displays information on the current position of the user based on the sensor information or the GPS information in the terminal 600, in an operation 916.

While the description of the present invention has been made to the exemplary embodiments, various changes and modifications may be made without departing from the scope of the invention. Therefore, the scope of the present invention should be defined by the appended claims rather than by the foregoing embodiments.

What is claimed is:

1. A system for providing information on an indoor infrastructure, the system comprising:
a spatial information acquiring apparatus configured to acquire a video image of a space, wireless network information, distance information or distance and angle information that a moving object moves to produce a space-acquired data;
a node information generation apparatus configured to estimate a location of the moving object on the basis of the distance and angular information that the moving object moves with the movement of the moving object and produce a plurality of moving object node information with the movement of the moving object using the estimated location information, the video image, the wireless network information, the distance information or POI (Point Of Interest) information extracted from the video image;
a spatial information generation apparatus configured to correct the location of the moving object on the basis of the location information of the respective moving object node information and produce final spatial information data using the moving object node information with a corrected location; and
a map generation apparatus configured to produce a map and spatial information of the space on the basis of the final spatial information data.

2. The system of claim 1, wherein the spatial information acquiring apparatus comprises:
a camera configured to provide the video image;
a radio detector configured to detect the wireless network information;
a distance measurement sensor configured to measure a 2D and 3D distance within the space; and
an encoder configured to extract the distance and angle information that the moving object moves.

3. The system of claim 1, wherein the spatial information acquiring apparatus further comprises:
a synchronization module configured to synchronize the video image, the wireless network information and the distance and angle information that the moving object moves and store the same to a data storage unit.

4. The system of claim 1, wherein the node information generation apparatus comprises:
a location prediction unit configured to predict the location that the moving object moves on the basis of the distance and angle information that the moving object moves;
a node information database (DB) that stores information on reference nodes to which location information is mapped;
a location estimation unit configured to search the node database for a reference node having similar location information to the predicted location within a predetermined range and estimate the location of the moving object on the basis of the location information of the searched reference node and the distance information; and
a node information generation unit configured to produce a new node in the space based on the estimated location and perform a mapping of the space-acquired data to the new node to produce the moving object node information.

5. The system of claim 4, wherein the node information generation unit is configured to extract the POI information using the video image in the space-acquired data.

6. The system of claim 1, wherein the map generation apparatus comprises:
a contour map generation unit configured to generate a contour map in a raster format containing nodes and video image in the respective nodes based on the respective moving object node information on the basis of the location and distance information of the moving object in the moving object node information;
a vector map generation unit configured to generate a map in a vector format based on the contour map;
a POI information production unit configured to produce the POI information on the basis of the video image of the nodes in the contour map in a raster format;
a node and link information production unit configured to produce a topology node and link information for a route planning within the space; and
a map information DB that stores the contour map, the vector format map, the video image, the POI information, the wireless network information and the topology node and link information.

7. An apparatus for providing information on an indoor infrastructure, the apparatus comprises:
a search request receiving unit configured to receive a search request for a specific indoor space from any terminal;
an information providing unit configured to transmit a map and spatial information corresponding to the specific indoor space to the terminal for the display thereof;
a node information providing unit configured to, when a specific node is selected in the displayed map and spatial information, search a video image, POI information or location information corresponding to the specific node and provide the searched result to the terminal.

8. The apparatus of claim 7, the information providing unit is configured to provide an outdoor map containing the specific indoor space, and the information providing unit is configured to, when a specific location is manipulated in the outdoor map, provide a map and spatial information of the indoor space corresponding to the specific location to the terminal for the display thereof.

9. The apparatus of claim 7, the search request receiving unit is configured to receive the search request on the basis of POI information located within the specific indoor space.

10. A method for providing information on an indoor infrastructure, the method comprises:
receiving a search request for a specific indoor space from any terminal;
providing a map and spatial information corresponding to the specific indoor space to the terminal to display the same;
when a specific node is selected in the displayed map and spatial information, searching a video image, POI information or location information corresponding to the selected node and providing the searched result to the terminal.

11. The method of claim 10, wherein said receiving search request comprises:
receiving the search request that uses any POI information within the specific indoor space.

12. The method of claim 10, wherein said providing to display comprises:
displaying on the terminal an outdoor map containing the specific indoor space; and
displaying on the terminal an enlarged specific indoor space having nodes in the displayed outdoor map.

13. The method of claim 10, wherein said providing to display further comprises:
displaying information about a current location of the terminal in the displayed specific indoor space.

14. The method of claim 13, said displaying information about a current location of the terminal comprises displaying information about a changed current location of the terminal in the displayed specific indoor space with the movement of the terminal.
